(19) United States
(12) Patent Application Publication
(10) Pub. No.: US 2026/0112681 A1
(43) Pub. Date: Apr. 23, 2026

(54) SECONDARY BATTERY AND METHOD FOR MANUFACTURING THE SAME

(71) Applicant: SAMSUNG SDI CO., LTD., Yongin-si (KR)

(72) Inventor: Jun Ho LEE, Yongin-si (KR)

(21) Appl. No.: 19/076,139

(22) Filed: Mar. 11, 2025

(30) Foreign Application Priority Data
Oct. 23, 2024 (KR) 10-2024-0146045

(51) Int. Cl. H01M 10/04; H01M 50/109; H01M 50/153; H01M 50/186; H01M 50/474; H01M 50/533; H01M 50/536; H01M 50/548; H01M 50/559

(52) U.S. Cl. CPC H01M 10/0431; H01M 10/049; H01M 50/109; H01M 50/153; H01M 50/186; H01M 50/474; H01M 50/533; H01M 50/536; H01M 50/548; H01M 50/559

(57) ABSTRACT

A secondary battery, including an electrode assembly having a first electrode, a separator, a second electrode, a first electrode tab connected to the first electrode, and a second electrode tab connected to the second electrode, a receiving can having one open surface to accommodate the electrode assembly, the receiving can being connected to the first electrode tab, and a cap assembly sealing the one open surface of the receiving can, the cap assembly being connected to the second electrode tab, wherein the receiving can includes a tab hole on a bottom surface thereof, and wherein at least a part of the first electrode tab is inserted into the tab hole and connected to the receiving can.

### CROSS-REFERENCE TO RELATED APPLICATION

This application claims priority under 35 U.S.C § 119 to Korean Patent Application No. 10-2024-0146045, filed in the Korean Intellectual Property Office on Oct. 23, 2024, the entire contents of which are hereby incorporated by reference.

### BACKGROUND

### 1. Field

The present disclosure relates to a secondary battery and a method for manufacturing the secondary battery.

### 2. Description of Related Art

Recently, as wearable devices such as headphones, earphones, smart watches, and body-attached medical devices using Bluetooth are widely used, it is desirable to use secondary batteries with high energy density and sufficiently small size. These secondary batteries are secondary batteries whose height is significantly smaller than their width depending on the characteristics of the usage environment, and may include coin cells and button cells.

A typical coin-type or button-type battery includes a receiving can that accommodates an electrode assembly having a jelly roll shape, and a cap assembly that is bonded to the top of the receiving can to seal the electrode assembly from the outside. The positive electrode tab extending upward from the electrode assembly is configured to be connected to an electrode terminal provided in the cap assembly, and the negative electrode tab extending downward is configured to be connected to the receiving can.

The above information disclosed in this Background section is for enhancement of understanding of the background of the present disclosure, and therefore, it may contain information that does not constitute related (or prior) art.

### SUMMARY

Embodiments include a secondary battery, including an electrode assembly having a first electrode, a separator, a second electrode, a first electrode tab connected to the first electrode, and a second electrode tab connected to the second electrode, a receiving can having one open surface to accommodate the electrode assembly, the receiving can being connected to the first electrode tab, and a cap assembly configured to seal the one open surface of the receiving can, the cap assembly being connected to the second electrode tab, wherein the receiving can includes a tab hole formed on a bottom surface thereof, and wherein at least a part of the first electrode tab is inserted into the tab hole and connected to the receiving can.

The first electrode tab may be on an outer surface of the electrode assembly and may have one end extending longer than one surface of the electrode assembly facing the bottom surface of the receiving can.

The tab hole may have a shape corresponding to a shape of a cross-section of one end of the electrode tab inserted into the tab hole.

The tab hole may be in at least a partial region of the bottom surface of the receiving can adjacent to a side wall portion of the receiving can.

The electrode assembly may include a winding of the first electrode, the separator, and the second electrode, resulting in a wound electrode assembly, and the tab hole has an arc shape corresponding to at least a part of an outer circumference of the wound electrode assembly.

A length of one end of the first electrode tab inserted into the tab hole may be smaller than a thickness of the bottom surface of the receiving can, the tab hole being in the bottom surface.

A thickness of the first electrode tab may be equal to a width of the tab hole in a radial direction of the bottom surface of the receiving can.

The electrode assembly may include a winding of the first electrode, the separator, and the second electrode, and a length of the first electrode tab in an arc direction corresponding to at least a part of an outer circumference of the wound electrode assembly may be equal to a length of the tab hole in the arc direction.

The first electrode tab may be pressed into the tab hole and connected to the receiving can.

The first electrode tab may be connected to the receiving can by welding, the first electrode tab being inserted into the tab hole.

The secondary battery may further include a welding bead within the tab hole.

The secondary battery may further include a sealing member sealing the tab hole on an external side of the bottom surface of the receiving can.

The secondary battery may further include an insulating member between the second electrode tab and a side wall portion of the receiving can.

The cap assembly may include a cap plate having a first opening, the cap plate being joined to one open surface of the receiving can, a terminal plate sealing the electrode assembly while covering the cap plate, the terminal plate passing through the first opening to be connected to the second electrode tab, and an insulating layer between the cap plate and the terminal plate.

Embodiments include a method of manufacturing a secondary battery, the method including forming an electrode assembly including a first electrode, a separator, a second electrode, a first electrode tab connected to the first electrode, and a second electrode tab connected to the second electrode, forming a tab hole in a bottom surface of a receiving can having one surface open to accommodate the electrode assembly therein, accommodating the electrode assembly in the receiving can to allow at least a part of the first electrode tab to be inserted into the tab hole to connect the first electrode tab to the receiving can, and connecting the second electrode tab to a cap assembly while sealing the open surface of the receiving can with the cap assembly.

Forming the electrode assembly may include connecting the first electrode tab to the first electrode on an outer surface of the electrode assembly, and forming one end of the first electrode tab to extend longer than one surface of the electrode assembly facing the bottom surface of the receiving can.

Forming the tab hole may include forming the tab hole in the bottom surface of the receiving can, the tab hole corresponding to a shape of a cross-section of one end of the electrode tab inserted into the tab hole.

Forming the tab hole may include forming the tab hole in at least a partial region of the bottom surface of the receiving can adjacent to a side wall portion of the receiving can.

The method may further include forming the electrode assembly by winding the first electrode, the separator, and the second electrode, wherein forming the tab hole may include forming an arc-shaped hole corresponding to at least a part of an outer circumference of the wound electrode assembly, on the bottom surface of the receiving can.

Forming the electrode assembly may include forming one end of the first electrode tab to extend longer than one surface of the electrode assembly facing the bottom surface of the receiving can, and forming a length of the one end of the first electrode tab to be smaller than a thickness of the bottom surface of the receiving can.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 is a perspective view of a secondary battery according to one or more embodiments of the present disclosure;

FIG. 2 is a bottom view of a secondary battery according to one or more embodiments of the present disclosure;

FIG. 3 is a cross-sectional view taken along line A-A of FIG. 1;

FIG. 4 is a view showing an electrode assembly according to one or more embodiments of the present disclosure;

FIG. 5 is an enlarged view of area B shown in FIG. 3;

FIG. 6 is a view showing an example of a first electrode tab and a tab hole according to one or more embodiments of the present disclosure;

FIG. 7 is a view showing an example of a first electrode tab according to one or more embodiments of the present disclosure;

FIG. 8 is a view showing a comparative example of a first electrode tab.

FIG. 9 is a view showing an example of a welding bead according to one or more embodiments of the present disclosure;

FIGS. 10 and 11 are views showing examples of sealing members according to one or more embodiments of the present disclosure; and

FIG. 12 is a flowchart for explaining a method for manufacturing a secondary battery according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

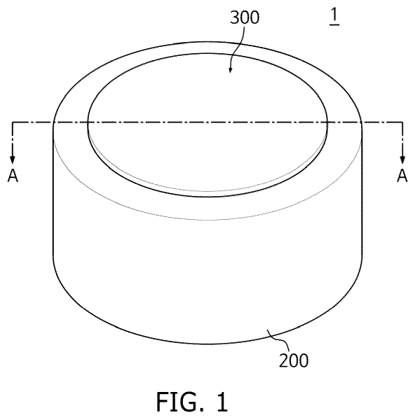

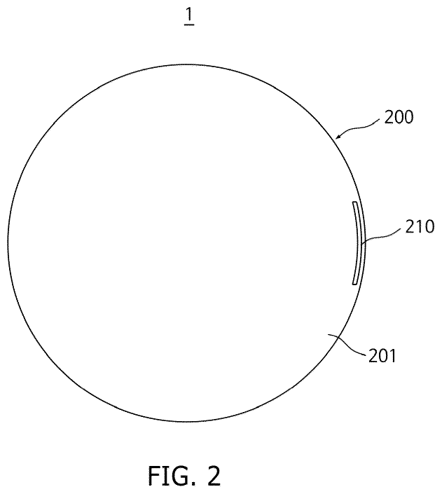

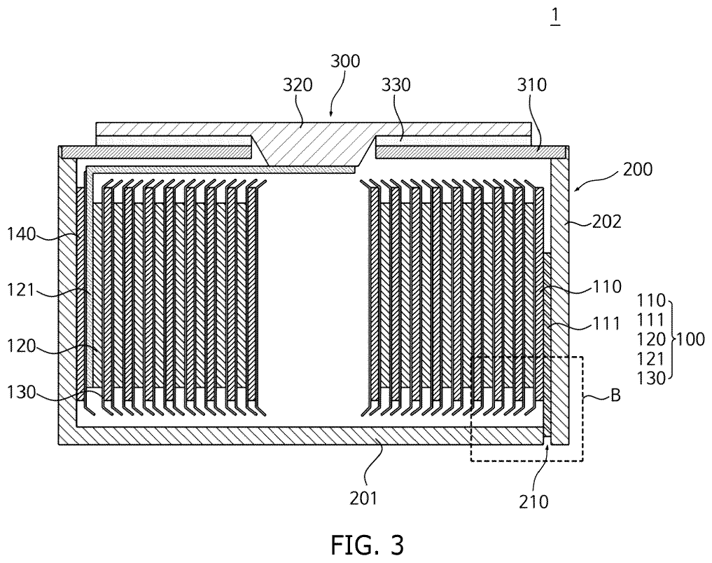

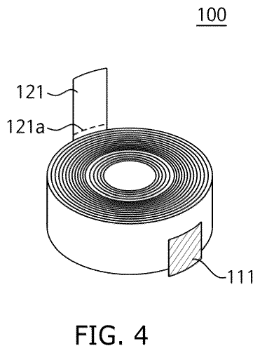

FIG. 1 is a perspective view of a secondary battery according to an embodiment of the present disclosure. FIG. 2 is a bottom view of a secondary battery according to one or more embodiments of the present disclosure. FIG. 3 is a cross-sectional view taken along line A-A of FIG. 1. FIG. 4 is a view showing an electrode assembly according to one or more embodiments of the present disclosure.

A secondary battery 1 according to one or more embodiments is a micro-sized secondary battery and may be a coin cell or a button cell but is not limited thereto and may be a cylindrical or pin-type battery.

The coin cell or button cell is a battery in the form of a thin coin or button and may refer to a battery having a ratio of height to diameter (height/diameter) of 1 or less but is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIGS. 1 to 4, a secondary battery 1 according to one or more embodiments of the present disclosure may include an electrode assembly 100, a receiving can 200, and a cap assembly 300.

The electrode assembly 100 may include a first electrode 110, a second electrode 120, a separator 130, a first electrode tab 111 connected to the first electrode 110, and a second electrode tab 121 connected to the second electrode 120. Here, the first electrode 110 may be a negative electrode, and the second electrode 120 may be a positive electrode. Of course, the opposite is also possible. For example, the electrode assembly 100 may be a wound electrode assembly 100 formed as a separator 130, which is an insulator, is interposed between a first electrode 110 and a second electrode 120 and is then wound, but this is merely one example.

According to one or more embodiments, the first electrode 110 may include a coated portion where an active material is applied on both surfaces of a first substrate formed of a thin metal plate, and a non-coated portion where a substrate is exposed because an active material is not applied. The first electrode 110 may include a non-coated portion formed on both surfaces of the first substrate in the wound longitudinal direction. The first electrode 110 may form a negative electrode by coating a negative electrode active material such as graphite or carbon on a metal substrate such as copper, copper alloy, nickel or nickel alloy.

According to one or more embodiments, a second electrode 120 may include a coated portion where an active material is applied on both surfaces of a second substrate formed of a thin metal plate, and a non-coated portion where a substrate is exposed because an active material is not applied. The second electrode 120 may include a non-coated portion formed on both surfaces of the second substrate in the wound longitudinal direction. The second electrode 120 may form a positive electrode by coating a positive electrode active material such as a transition metal oxide on a metal substrate such as aluminum or an aluminum alloy.

According to one or more embodiments, a separator 130 may be disposed between the first electrode 110 and the second electrode 120. The separator 130 may insulate the first electrode 110 and the second electrode 120 and exchange lithium ions between the first electrode 110 and the second electrode 120. The separator 130 may have a sufficient length to completely insulate the area between the first electrode 110 and the second electrode 120 even if the electrode assembly 100 shrinks or expands during the charging and discharging process of the secondary battery 1.

The first electrode tab 111 may be disposed on the outer surface of the electrode assembly 100. The first electrode tab 111 may be formed separately and connected to the non-coated portion of the first electrode 110 or may be formed by punching out a part of the non-coated portion.

The first electrode tab 111 may be connected to the receiving can 200. The first electrode tab 111 may not be bent and may be inserted into a tab hole 210 formed on the bottom surface 201 of the receiving can 200 to be connected to the receiving can 200. In one or more embodiments, one end of the first electrode tab 111 may extend longer than one surface of the electrode assembly 100 facing the bottom surface 201 of the receiving can 200. One end of the first electrode tab 111 that extends longer than one surface of the electrode assembly 100 may be inserted into a tab hole 210 formed in the bottom surface 201 of the receiving can 200 and connected to the receiving can 200. The first electrode 110 and the receiving can 200 may be electrically connected through the first electrode tab 111.

The second electrode tab 121 may be disposed on the outer surface of the electrode assembly 100. The second electrode tab 121 may be formed separately and connected to the non-coated portion of the second electrode 120 or may be formed by punching out a part of the non-coated portion. The second electrode tab 121 may be formed longer than the first electrode tab 111.

The second electrode tab 121 may be connected to the cap assembly 300. The second electrode tab 121 may include a bent portion 121a that is bent on one surface of the electrode assembly 100 facing the cap assembly 300. The second electrode tab 121 may be bent and connected to one inner surface of the cap assembly 300. The second electrode 120 and the cap assembly 300 may be electrically connected through the second electrode tab 121.

It is illustrated in FIG. 3 that the first electrode tab 111 is electrically connected to the receiving can 200, and the second electrode tab 121 is electrically connected to the cap assembly 300, but the opposite case is also possible.

A secondary battery 1 according to one or more embodiments of the present disclosure may further include an insulating member 140 disposed in an area between the second electrode tab 121 and the side wall portion 202 of the receiving can 200. The insulating member 140 may surround the second electrode tab 121 disposed on the outer peripheral surface of the electrode assembly 100 and be disposed between the second electrode tab 121 and the side wall portion 202 of the receiving can 200. The insulating member 140 may insulate a space between the receiving can 200, which is connected to the first electrode tab 111, and the second electrode tab 121 having the opposite polarity.

According to one or more embodiments, the receiving can 200 may have one side open to receive the electrode assembly 100 and may be connected to the first electrode tab 111. The receiving can 200 may be electrically connected to the first electrode 110 through the first electrode tab 111 and function as a negative electrode.

According to one or more embodiments, the receiving can 200 may form the overall appearance of the secondary battery 1. For example, the receiving can 200 may have an open cylindrical shape. The receiving can 200 may include a circular bottom surface 201 and a side wall portion 202 extending vertically from the circumference of the bottom surface 201. The receiving can 200 may be formed so that the diameter of the bottom surface 201 is larger than the height of the side wall portion 202, and in this way, the secondary battery 1 may be configured as a button or coin type battery.

According to one or more embodiments, the upper surface facing the bottom surface 201 of the receiving can 200 may be open to expose an accommodation space capable of accommodating the electrode assembly 100. After the electrode assembly 100 is accommodated in the receiving can 200, the electrode assembly 100 may be sealed by covering one open surface of the receiving can 200 with the cap assembly 300. Specifically, the upper end of the side wall of the receiving can 200 may have a step difference from the outside to the inside. The cap assembly 300 may be joined by metal bonding (e.g., welding, brazing, soldering, etc.) while in contact with the upper terminal of the side wall of the receiving can 200 so as to engage with the step of the upper terminal of the side wall of the receiving can 200, but other scenarios are possible.

The receiving can 200 may include a tab hole 210 formed on the bottom surface 201. At least a part of the first electrode tab 111 may be inserted into the tab hole 210 and connected to the receiving can 200. In one or more embodiments, the first electrode tab 111 may be pressed into the tab hole 210 and connected to the receiving can 200. In another embodiment, the first electrode tab 111 may be welded to the receiving can 200 in a state that the first electrode tab 111 has been inserted into the tab hole 210. Of course, the first electrode tab 111 may be connected by welding after being pressed into the tab hole 210. Through the position of the tab hole 210 formed in the receiving can 200, the position of the first electrode tab 111 of the electrode assembly 100 accommodated in the receiving can 200 may be easily identified from the outside of the case 200.

The tab hole 210 may have a shape corresponding to the cross-sectional shape of one end into which the first electrode tab 111 is inserted into the tab hole 210. In other words, a shape of the tab hole 210 may correspond to the cross-section of the inserted end of the electrode tab 111. The tab hole 210 may be formed in at least a partial region of the bottom surface 201 of the receiving can 200 adjacent to the side wall portion 202 of the receiving can 200.

The electrode assembly 100 may be formed by winding a first electrode 110, a separator 130, and a second electrode 120. As illustrated in FIG. 2, the tab hole 210 formed in the bottom surface 201 of the receiving can 200 may have an arc shape corresponding to at least a part of the outer circumference of the wound electrode assembly 100.

In one or more embodiments, the cap assembly 300 may seal one open surface of the receiving can 200. The cap assembly 300 may cover one open surface of the receiving can 200 to seal the electrode assembly 100 from the outside. The cap assembly 300 may be connected to the second electrode tab 121. The cap assembly 300 may function as a positive electrode by being electrically connected to the second electrode 120 through the second electrode tab 121.

According to one or more embodiments, the cap assembly 300 may include a cap plate 310, a terminal plate 320, and an insulating layer 330. The cap plate 310 may have a first opening formed in a large central portion and may come into contact with one open surface of the receiving can 200. The cap plate 310 may be seated on the side wall portion 202 of the receiving can 200 and joined to the receiving can 200. The cap plate 310 may have a disk shape having a first opening at the center and may have an outer end surrounding the first opening and corresponding to the shape of the receiving can 200.

In one or more embodiments, the terminal plate 320 may seal the electrode assembly 100 by covering the cap plate 310. The protrusion of the terminal plate 320 may be connected to the second electrode tab 121 of the electrode assembly 100 by penetrating the first opening of the cap plate 310 and the second opening of the insulating layer 330. The terminal plate 320 may be disposed on the insulating layer 330 and electrically insulated from the cap plate 310. The protrusion of the terminal plate 320 extends to pass through the center of its lower surface without contacting the first opening, so as to come into contact with the second electrode tab 121 of the electrode assembly 100. The terminal plate 320 may function as a positive electrode by being connected to the second electrode 120 through the second electrode tab 121. The terminal plate 320 may be disposed on the top layer of the cap assembly 300 and may be connected to an external terminal for connecting to a load.

The insulating layer 330 may be disposed between the cap plate 310 and the terminal plate 320 to insulate an area between the cap plate 310 and the terminal plate 320. Because the cap plate 310 is connected to the receiving can 200 that comes into contact with the first electrode tab 111, and the terminal plate 320 is connected to the second electrode tab 121, an insulating layer 330 may be disposed between the cap plate 310 and the terminal plate 320 to insulate the cap plate 310 and the terminal plate 320. The insulating layer 330 may have a disk shape which has a second opening and in which the second opening is located at the center. The insulating layer 330 may be disposed on the cap plate 310 and may have a second opening having the same center as the first opening of the cap plate 310 and having a diameter smaller than or equal to the diameter of the first opening. An insulating layer 330 having such a configuration may electrically insulate a terminal plate 320 and a cap plate 310 which are disposed on the upper portion of the insulating layer 330.

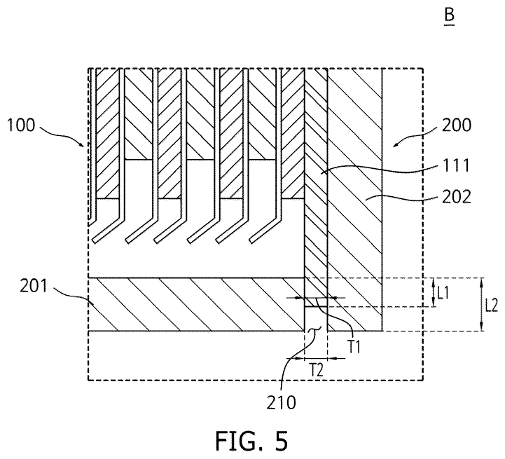

FIG. 5 is an enlarged view of area B shown in FIG. 3.

Referring to FIGS. 3 and 5, a tab hole 210 may be formed in at least a partial region of a bottom surface 201 of a receiving can 200 according to one or more embodiments of the present disclosure. The tab hole 210 may be formed in at least a partial region of the bottom surface 201 of the receiving can 200 adjacent to the side wall portion 202 of the receiving can 200.

The first electrode tab 111 may be disposed on the outer surface of the electrode assembly 100) and may extend longer than one surface of the electrode assembly 100 facing the bottom surface 201 of the receiving can 200. One end of the first electrode tab 111 that extends longer than one surface of the electrode assembly 100 may be inserted into the tab hole 210.

The length (L1) of one end of the first electrode tab 111 inserted into the tab hole 210 may be smaller than the thickness (L2) of the bottom surface 201 of the receiving can 200 in which the tab hole 210 is formed. That is, the length (L1) of one end of the first electrode tab 111 may be smaller than the thickness (L2) of the bottom surface 201 of the receiving can 200 so that the first electrode tab 111 does not protrude outward from the bottom surface 201 of the receiving can 200 by penetrating the tab hole 210.

The thickness (T1) of the first electrode tab 111 may be equal to the width (T2) of the tab hole 210 in the radial direction of the bottom surface 201 of the receiving can 200. In order to prevent the electrolyte solution injected into the receiving can 200 from leaking to the outside through the tab hole 210, the thickness (T1) of the first electrode tab 111 may be made the same as the width (T2) of the tab hole 210 so that the first electrode tab 111 may be fitted into the tab hole 210. As another example, the thickness (T1) of the first electrode tab 111 may be formed thicker than the width (T2) of the tab hole 210. The first electrode tab 111, which is formed to be thicker than the width (T2) of the tab hole 210, may be connected to the first electrode tab 111 to the receiving can 200 by being forcibly fitted or pressed into the tab hole 210.

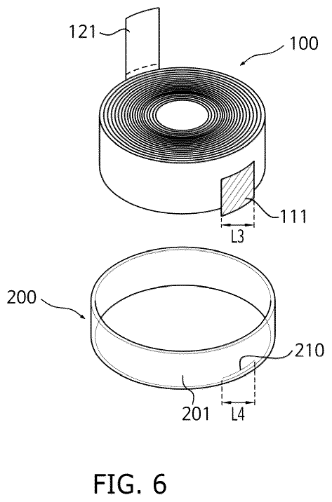

FIG. 6 is a view showing an example of a first electrode tab and a tab hole according to one or more embodiments of the present disclosure.

Referring to FIGS. 3 and 6, an electrode assembly 100 according to one or more embodiments of the present disclosure may be formed by winding a first electrode 110, a separator 130, and a second electrode 120. The first electrode tab 111 may be disposed on the outer surface of the electrode assembly 100) and may extend longer than one surface of the electrode assembly 100 facing the bottom surface 201 of the receiving can 200. The first electrode tab 111 may be disposed to be curved on the outer surface of the electrode assembly 100 according to the shape of the outer circumference of the wound electrode assembly 100.

A tab hole 210 may be formed on the bottom surface 201 of the receiving can 200. The tab hole 210 may have an arc shape corresponding to at least a part of the outer circumference of the wound electrode assembly 100.

The length (L3) of the first electrode tab may be equal to the length (L4) of the tab hole in an arc direction corresponding to (e.g., matching) at least a part of the outer circumference of the wound electrode assembly 100.

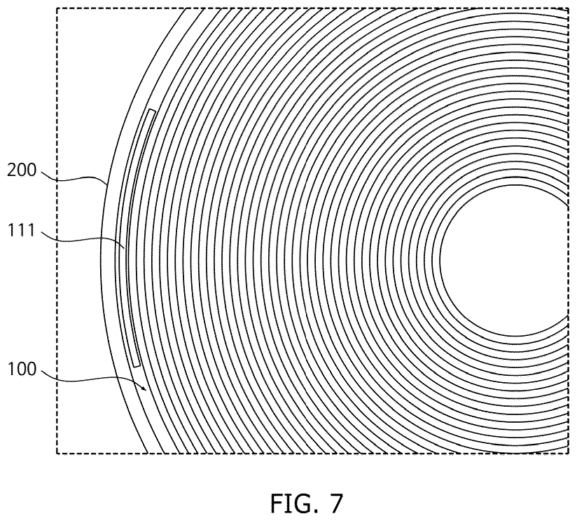

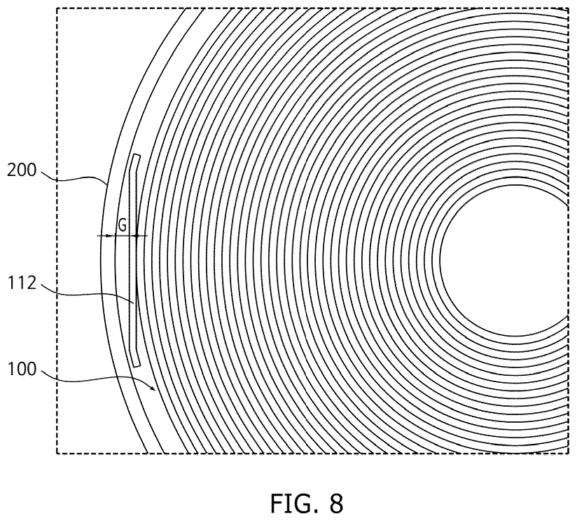

FIG. 7 is a view showing an example of a first electrode tab according to one or more embodiments of the present disclosure. FIG. 8 is a view showing a comparative example of a first electrode tab.

Referring to FIGS. 6 and 7, the first electrode tab 111 according to one or more embodiments of the present disclosure may be disposed to be curved on the outer surface of the electrode assembly 100 according to the shape of the outer circumference of the wound electrode assembly 100. As described above, the first electrode tab 111 may be inserted into the tab hole 210 formed on the bottom surface of the receiving can 200 in an unbent state, and connected to the receiving can 200. Accordingly, the first electrode tab 111 may be disposed adjacent to the side wall of the receiving can 200, and no space loss may occur between the lower surface of the electrode assembly 100 and the bottom surface of the receiving can 200.

Referring to FIG. 8, as a comparative example, the first electrode tab 112 may be disposed on the outer surface of the electrode assembly 100 and then bent to be welded to the bottom surface of the receiving can 200. When the first electrode tab 112 is bent, a gap (G) is required between the receiving can 200 and the first electrode tab 112, and accordingly, a space loss may occur.

That is, according to one or more embodiments of the present disclosure, the first electrode tab 111 may be connected to the bottom surface of the receiving can 200 without bending, thereby reducing space loss, and securing internal space within the secondary battery 1 to improve energy density.

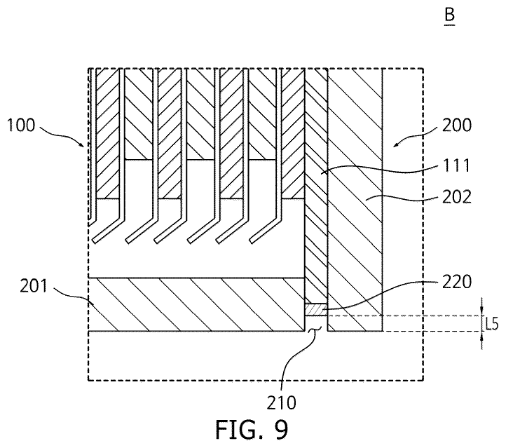

FIG. 9 is a view showing an example of a welding bead according to one or more embodiments of the present disclosure.

Referring to FIG. 9, a first electrode tab 111 according to one or more embodiments of the present disclosure may be inserted into a tab hole 210 and connected to a receiving can 200. The first electrode tab 111 may be welded to the receiving can 200 in a state that the first electrode tab 111 has been inserted into the tab hole 210.

A welding bead 220 formed by welding the first electrode tab 111 to the receiving can 200 may be formed within the tab hole 210. For example, the welding bead 220 may be formed within a tab hole 210 at a predetermined height (L5) from the bottom surface 201 of the receiving can 200. Because the welding bead 220 is formed within the tab hole 210, the welding bead 220 may not protrude from the bottom surface 201 of the receiving can 200.

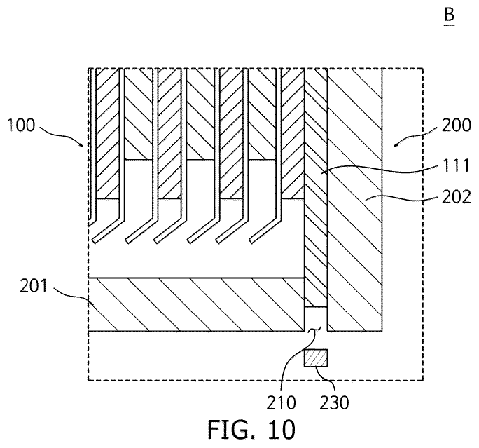

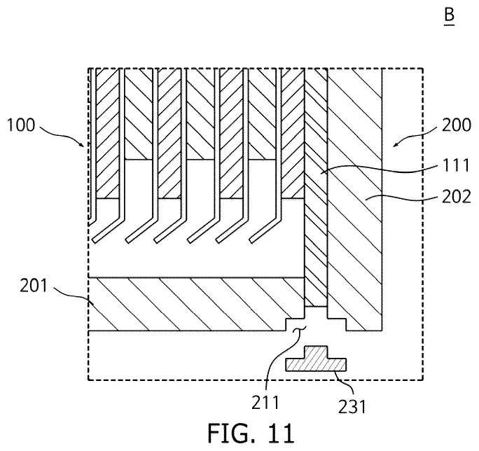

FIGS. 10 and 11 are views showing examples of sealing members according to one or more embodiments of the present disclosure.

Referring to FIG. 10, a secondary battery 1 according to one or more embodiments of the present disclosure may further include a sealing member 230. The sealing member 230 may seal the tab hole 210 on the outside of the bottom surface 201 of the receiving can 200. That is, the sealing member 230 may seal one side surface of the exposed terminal of the first electrode tab 111 inserted into the tab hole 210, from the outside of the tab hole 210. A sealing member 230 configured in this manner may prevent the electrolyte solution injected into the receiving can 200 from leaking through the tab hole 210.

Referring to FIG. 11, a sealing member 231 according to one or more embodiments of the present disclosure may have a shape having a wide bottom surface and protruding from a central region to seal a tab hole 211. The tab hole 211 may be formed so that the opening into which the first electrode tab 111 is inserted is narrow to match the shape of the sealing member 231, but the opening corresponding to the bottom surface of the sealing member 231 may be formed wide.

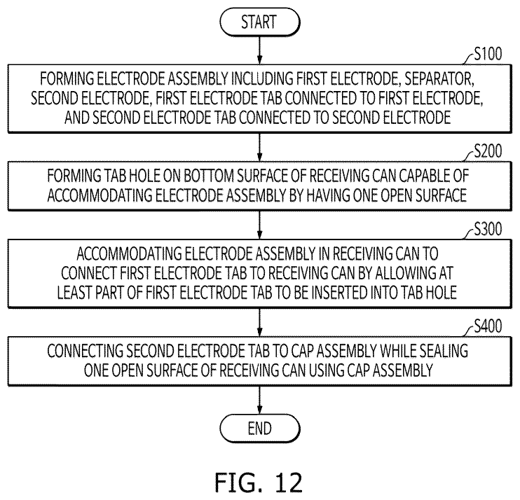

FIG. 12 is a flowchart for explaining a method for manufacturing a secondary battery according to one or more embodiments of the present disclosure.

Referring to FIG. 12, a method for manufacturing a secondary battery according to an embodiment of the present disclosure may include a step (S100) of forming an electrode assembly including a first electrode, a separator, a second electrode, a first electrode tab connected to the first electrode, and a second electrode tab connected to the second electrode, a step (S200) of forming a tab hole in a bottom surface of a receiving can having one surface open to accommodate the electrode assembly, a step (S300) of accommodating the electrode assembly in the receiving can such that at least a part of the first electrode tab is inserted into the tab hole to connect the first electrode tab to the receiving can, and a step (S400) of connecting the second electrode tab to the cap assembly while sealing the open surface of the receiving can with a cap assembly. Hereinafter, steps S100 to S400 are specifically described with reference to FIGS. 1 to 6.

In step S100, an electrode assembly 100, which includes a first electrode 110, a separator 130, a second electrode 120, a first electrode tab 111 connected to the first electrode 110, and a second electrode tab 121 connected to the second electrode, may be formed. Here, the first electrode 110 may be a negative electrode, and the second electrode 120 may be a positive electrode. Of course, the opposite is also possible. For example, the electrode assembly 100 may be a wound electrode assembly 100 formed as a separator 130, which is an insulator, is interposed between a first electrode 110 and a second electrode 120 and is then wound, but the embodiment is not limited to this example.

According to one or more embodiments, the step of forming the electrode assembly 100 may include the step of connecting the first electrode tab 111 to the first electrode 110 disposed on the outer surface of the electrode assembly 100, and forming one end of the first electrode tab 111 to be extended longer than one surface of the electrode assembly 100 facing the bottom surface 201 of the receiving can 200.

According to one or more embodiments, the step of forming the electrode assembly 100 may include the step of forming one end of the first electrode tab 111 to be longer than one surface of the electrode assembly 100 facing the bottom surface 201 of the receiving can 200 and forming the thickness of the one end of the first electrode tab 111 to be smaller than the thickness of the bottom surface 201 of the receiving can 200 where the tab hole 210 is formed.

In step S200, a tab hole 210 may be formed on the bottom surface 201 of the receiving can 200 corresponding to the cross-sectional shape of one end into which the first electrode tab 111 is inserted.

According to one or more embodiments, the step of forming the tab hole 210 may include the step of forming the tab hole 210 in at least a partial region of the bottom surface 201 of the receiving can 200 adjacent to the side wall portion 202 of the receiving can 200.

According to one or more embodiments, the step of forming the tab hole 210 may include the step of forming an arc-shaped hole corresponding to at least a part of the outer circumference of the wound electrode assembly 100, in the bottom surface 201 of the receiving can 200.

In step S300, the electrode assembly 100 may be accommodated in the receiving can 200 such that at least a part of the first electrode tab 111 is inserted into the tab hole 210, and the first electrode tab 111 is connected to the receiving can 200. The first electrode tab 111 may not be bent and inserted into the tab hole 210 formed on the bottom surface 201 of the receiving can 200 to be connected to the receiving can 200. The first electrode 110 and the receiving can 200 may be electrically connected through the first electrode tab 111.

In step S400, the second electrode tab 121 may be connected to the cap assembly 300 while sealing one open surface of the receiving can 200 using the cap assembly 300. The second electrode tab 121 may be bent on one surface of the electrode assembly 100 facing the cap assembly 300 and then connected to one inner surface of the cap assembly 300. The second electrode 120 and the cap assembly 300 may be electrically connected through the second electrode tab 121.

According to some embodiments of the present disclosure, a negative electrode tab of an electrode assembly accommodated in a case of a secondary battery may be connected to a receiving can without bending the negative electrode tab, thereby reducing space loss and improving energy density by securing internal space within the secondary battery.

According to some embodiments of the present disclosure, a negative electrode tab of an electrode assembly accommodated in a case of a secondary battery may be connected to a receiving can without bending the negative electrode tab, thereby alleviating damage to the tab that may occur when the tab is bent.

According to some embodiments of the present disclosure, the position, at which a negative electrode tab of an electrode assembly accommodated in a case of a secondary battery is disposed, can be accurately confirmed from the outside of the case.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

DESCRIPTION OF SOME REFERENCE SYMBOLS

| | |
|---|---|
| 1: secondary battery | 100: electrode assembly |
| 110: first electrode | 111: first electrode tab |
| 120: second electrode | 121: second electrode tab |
| 130: separator | 200; receiving can |
| 210: tab hole | 220: welding bead |
| 230: sealing member | 300: cap assembly |
| 310: cap plate | 320: terminal plate |
| 330: insulating layer | |

What is claimed is:

1. A secondary battery, comprising:
an electrode assembly comprising a first electrode, a separator, a second electrode, a first electrode tab connected to the first electrode, and a second electrode tab connected to the second electrode;
a receiving can having one open surface to accommodate the electrode assembly, the receiving can being connected to the first electrode tab; and
a cap assembly sealing the one open surface of the receiving can, the cap assembly being connected to the second electrode tab,
wherein the receiving can comprises a tab hole on a bottom surface thereof, and
wherein at least a part of the first electrode tab is inserted into the tab hole and connected to the receiving can.

2. The secondary battery as claimed in claim 1, wherein the first electrode tab is on an outer surface of the electrode assembly and has one end extending longer than one surface of the electrode assembly facing the bottom surface of the receiving can.

3. The secondary battery as claimed in claim 1, wherein the tab hole has a shape corresponding to a shape of a cross-section of one end of the electrode tab inserted into the tab hole.

4. The secondary battery as claimed in claim 1, wherein the tab hole is in at least a partial region of the bottom surface of the receiving can adjacent to a side wall portion of the receiving can.

5. The secondary battery as claimed in claim 1, wherein:
the electrode assembly includes a winding of the first electrode, the separator, and the second electrode, resulting in a wound electrode assembly, and
the tab hole has an arc shape corresponding to at least a part of an outer circumference of the wound electrode assembly.

6. The secondary battery as claimed in claim 1, wherein a length of one end of the first electrode tab inserted into the tab hole is smaller than a thickness of the bottom surface of the receiving can, the tab hole being in the bottom surface.

7. The secondary battery as claimed in claim 1, wherein a thickness of the first electrode tab is equal to a width of the tab hole in a radial direction of the bottom surface of the receiving can.

8. The secondary battery as claimed in claim 1, wherein:
the electrode assembly includes a winding of the first electrode, the separator, and the second electrode, and
a length of the first electrode tab in an arc direction corresponding to at least a part of an outer circumference of the wound electrode assembly is equal to a length of the tab hole in the arc direction.

9. The secondary battery as claimed in claim 1, wherein the first electrode tab is pressed into the tab hole and connected to the receiving can.

10. The secondary battery as claimed in claim 1, wherein the first electrode tab is connected to the receiving can by welding, the first electrode tab being inserted into the tab hole.

11. The secondary battery as claimed in claim 10, further comprising a welding bead within the tab hole.

12. The secondary battery as claimed in claim 1, further comprising a sealing member sealing the tab hole on an external side of the bottom surface of the receiving can.

13. The secondary battery as claimed in claim 1, further comprising an insulating member between the second electrode tab and a side wall portion of the receiving can.

14. The secondary battery as claimed in claim 1, wherein the cap assembly comprises:
a cap plate having a first opening, the cap plate being joined to one open surface of the receiving can;
a terminal plate sealing the electrode assembly while covering the cap plate, the terminal plate passing through the first opening to be connected to the second electrode tab; and
an insulating layer between the cap plate and the terminal plate.

15. A method of manufacturing a secondary battery, the method comprising:
forming an electrode assembly comprising a first electrode, a separator, a second electrode, a first electrode tab connected to the first electrode, and a second electrode tab connected to the second electrode;
forming a tab hole in a bottom surface of a receiving can having one surface open to accommodate the electrode assembly therein;
accommodating the electrode assembly in the receiving can to allow at least a part of the first electrode tab to be inserted into the tab hole to connect the first electrode tab to the receiving can; and
connecting the second electrode tab to a cap assembly while sealing the open surface of the receiving can with the cap assembly.

16. The method as claimed in claim 15, wherein forming the electrode assembly comprises:
connecting the first electrode tab to the first electrode on an outer surface of the electrode assembly, and
forming one end of the first electrode tab to extend longer than one surface of the electrode assembly facing the bottom surface of the receiving can.

17. The method as claimed in claim 15, wherein forming the tab hole comprises forming the tab hole on the bottom surface of the receiving can, the tab hole corresponding to a shape of a cross-section of one end of the electrode tab inserted into the tab hole.

18. The method as claimed in claim 15, wherein forming the tab hole comprises forming the tab hole in at least a partial region of the bottom surface of the receiving can adjacent to a side wall portion of the receiving can.

19. The method as claimed in claim 15, further comprising forming the electrode assembly by winding the first electrode, the separator, and the second electrode, wherein forming the tab hole comprises forming an arc-shaped hole corresponding to at least a part of an outer circumference of the wound electrode assembly, on the bottom surface of the receiving can.

20. The method as claimed in claim 15, wherein forming the electrode assembly comprises:
forming one end of the first electrode tab to extend longer than one surface of the electrode assembly facing the bottom surface of the receiving can, and
forming a length of the one end of the first electrode tab to be smaller than a thickness of the bottom surface of the receiving can.
